(19) United States
(12) Patent Application Publication
(10) Pub. No.: US 2010/0102468 A1
(43) Pub. Date: Apr. 29, 2010

(54) METHOD FOR MANUFACTURING AN ENVIRONMENT-FRIENDLY COMPOSITE MATERIAL

(76) Inventor: HSIN-MIN CHEN, Taiping City (TW)

Correspondence Address: Dr. BANGER SHIA;Patent Office of Bang Shia, 102 Lindencrest Ct., Sugar Land, TX, 77479-5201, US

(21) Appl. No.: 12/258,666

(22) Filed: Oct. 27, 2008

(51) Int. Cl. B29B 17/00

(52) U.S. Cl. 264/37.29

(57) ABSTRACT

A method for manufacturing an environment-friendly composite material, using polyolefin particles and powder rubber that are made from reclaimed plastic and reclaimed rubber as a raw material, comprises the steps of: powder rubber surface treatment: using interface treatment coupling agent to perform a powder rubber surface treatment to improve the compatibility between the polyolefin particles and the powder rubber; additive treatment: adding the selected additive according to the desired function; blending: melt-blending the polyolefin particles and the powder rubber evenly; extrusion granulating: granulating the evenly-blended polyolefin grain and powder rubber by means of extrusion using a processing machine so as to form the granulated raw material, which has a wide application range and is environment-friendly.

### BACKGROUND OF THE INVENTION

1. Field of the Invention

The present invention relates to a method for recycling waster plastic and rubber, and more particularly to a method for manufacturing an environment-friendly composite material.

2. Description of the Prior Art

With the prosperity of economy and the development of scientific technology, lots of vehicles and motorcycles are brought into market, thus generating more than two billions waste tyres every year. Additionally, various containers such as PET bottles, packaging boxes are mostly made of polyethylene, polypropylene, ethylene vinyl acetate or other plastic materials. All the above generated wastes were abandoned or buried in the early days, thus causing serious pollution. In order to reduce the pollution, plastic wastes are later reclaimed and produced into new products in various manners. However, almost all the existing re-manufacturing methods utilize the same reclaimed material to perform the re-manufacturing operation, and few of them utilize multiple reclaimed materials to produce the products with relatively wide application range.

For example, in Taiwan, every year, there are produced 7.27 million waste tires reaches, 1 million metric tons of waste plastic and 2 hundred and 40 million PET bottles, so they cannot be treated in time at all according to the existing recycle and reuse technology. Presently, the waste tires are normally reclaimed to produce the rubber board, highway guard rail, artificial turf, sports court, protective pad, etc. However, the application range is still limited and to be extended. The PET bottles can be reclaimed to produce textile fiber, but the reclaiming effect is still required to be improved.

Although there are many technologies for the resource reclaim and recycle, the conventional reclaiming methods and technologies are too limited to deal with the great amount of waste. Accordingly, it has already become an urgent issue to ceaselessly research and develop the resource reclaim and recycle technology.

According to this, after multiple modifications and improvements, the inventor of the present invention, based on many years of experiences, has designed a method for manufacturing an environment-friendly composite material.

### SUMMARY OF THE INVENTION

The technical problems to be solved:

The conventional reclaiming methods and technologies are too limited to deal with the great amount of waste rubber, waste plastic, and almost all the waste rubber and the waste plastic can only be reclaimed and recycled in a single manner, so that how to extend the application of the recycling technology has become the technical problem to be solved.

The technical features for solving the above problems:

The present invention provides a method for manufacturing an environment-friendly composite material using polyolefin particles and powder rubber that are made from reclaimed plastic and reclaimed rubber as a raw material, comprises the steps of: powder rubber surface treatment: using interface treatment coupling agent to perform a powder rubber surface treatment to improve the compatibility between the polyolefin particles and the powder rubber; additive treatment: adding the selected additive according to the desired function; blending: melt-blending the polyolefin particles and the powder rubber evenly, the polyolefin particles to the powder rubber are blended according to a predetermined ratio to control the melt flow index MI larger 0.5 g/10 min (10 kg loading, 190° C.); and extrusion granulating: granulating the evenly-blended polyolefin grain and powder rubber by means of extrusion using a processing machine so as to form the granulated raw material, which can be made into the desired structure by injection molding or hot pressing molding.

As compared to the prior art, the present invention has the following advantages:

The primary objective of the present invention is to provide a method for manufacturing an environment-friendly composite material, which adopts the technology of waster powder rubber surface treatment, the blending technology and the technology of extrusion granulation to fabricate the waste plastic and the waste rubber into raw material master-batch, which can be made into finished products by hot pressing or injection molding. The raw material master-batch produced by the method of the present invention have a wide application range and has the advantages of environment-friendly and reducing waste generation.

### BRIEF DESCRIPTION OF THE DRAWINGS

FIG. 1 is a flow block diagram of a method for manufacturing an environment-friendly composite material in accordance with a first embodiment of the present invention; and

FIG. 2 is a flow block diagram of a method for manufacturing an environment-friendly composite material in accordance with a second embodiment of the present invention.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

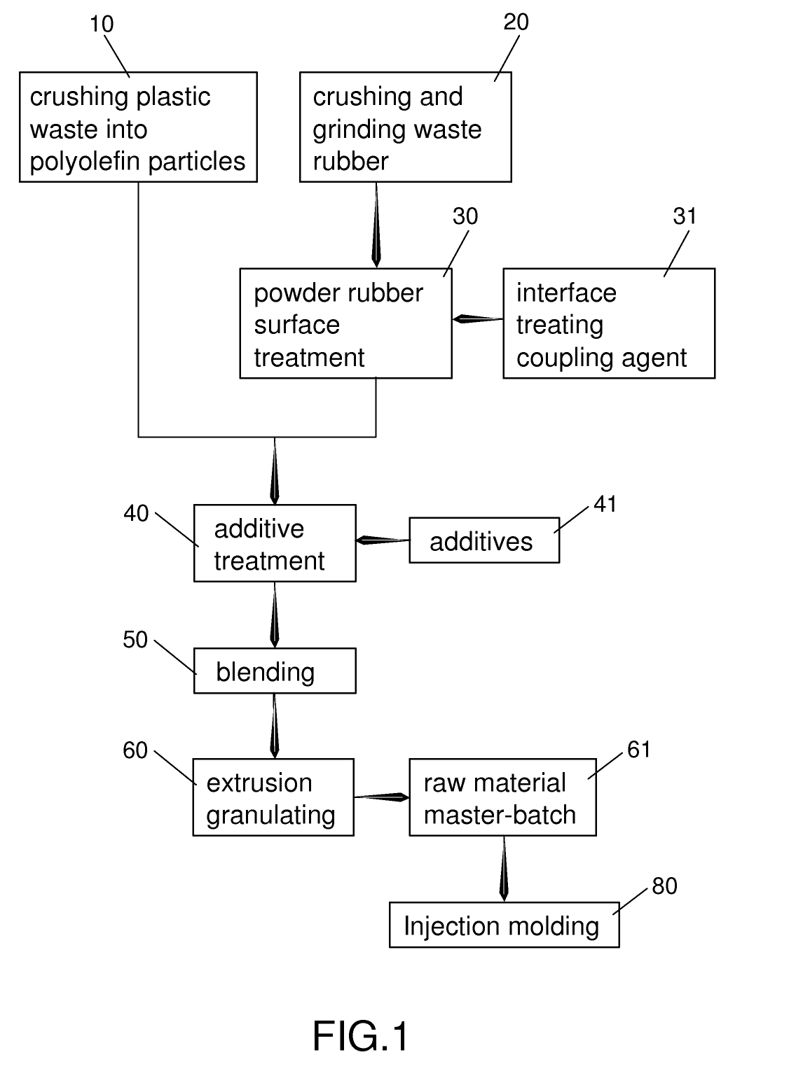

Referring to FIG. 1, a method for manufacturing an environment-friendly composite material in accordance with a first preferred embodiment of the present invention from waste plastic and waste rubber comprises the steps of:

Crushing plastic waste into polyolefin particles 10: using a crushing machine to crush high-intensity polyethylene, low-intensity polyethylene, polypropylene or EVA plastic waste, preferably the high-intensity polyethylene plastic waste into polyolefin particles.

Crushing and grinding waste rubber 20: the waste rubber (commonly, it is in the form of waste tires, rubber hoses, rubber shoes that are made from butadiene rubber, styrene butadiene rubber or natural rubber) is crushed to 40-60 mesh (mesh is a unit representing the number of the meshes per inch, the greater the value of the mesh is, the smaller the meshes will be, and the smaller the particles, which can be passed through the meshes are), and a grinder is used to grind the waste rubber into powder rubber with an average particle diameter between 10 um-100 um.

Powder rubber surface treatment 30: using an interface treating coupling agent 31 to treat the powder rubber surface to improve the compatibility between the polyolefin particles and the powder rubber.

Additive treatment 40: according to desired functions, adding different additives 41 into the raw material (the polyolefin particles and the powder rubber), the additives 41 can be such as heat stabilizer, processing aid, flame resisting agent, ultraviolet ray absorption agent.

Blending 50: using a blending machine to evenly melt-blend the polyolefin particles and the powder rubber, the ratio of the polyolefin particles to the powder rubber is between 1:1 and 1:3.5, preferably about 1:2, the melt flow index MI is controlled larger than 0.5 g/10 min (10 kg loading. 190° C.), the melt flow index MI is called melt index for short, showing the value of the flowability of the plastic material during processing operation.

Extrusion granulating 60: using a processing machine to granulate the evenly-blended polyolefin particles and powder rubber into raw material master-batch 61 by means of extrusion.

Injection molding 80: using an injection molding machine or a hydraulic machine to manufacture the raw material master-batch 61 into finished products by means of hot pressing injection or hot pressing molding.

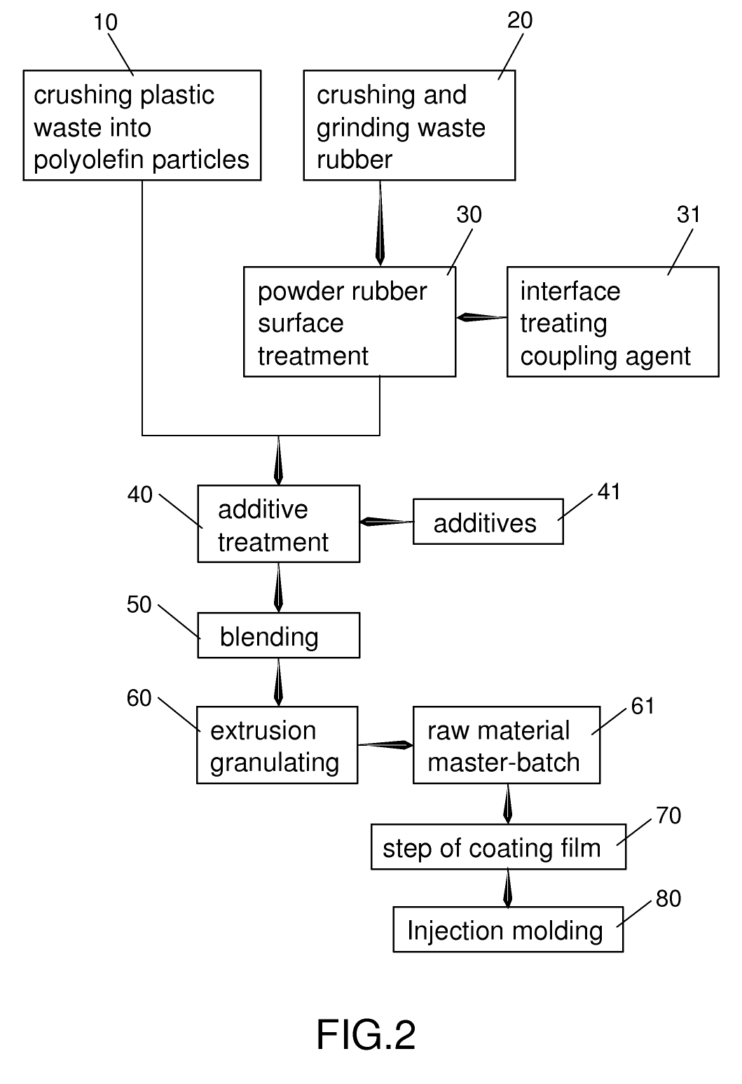

Further referring to FIG. 2, a method for manufacturing an environment-friendly composite material in accordance with a second embodiment of the present invention further comprises a step of coating film 70 to attach a color film during process of injection molding 80, so as to make the finished product more beautiful. Accordingly, if the film coating technology is not used, the finished product made according to the method of the present invention can only be black, such as a black stopping block in a parking lot, a black protection fence batten, a black anti-collision block, etc.

The color coating film is made of EVA, TPR, processing aid, pigments and filling agent.

The raw material master-batch 61 can be made into buffer floor bricks, floor boards, stopping blocks for a parking lot, road fence battens, road anti-collision blocks, industrial stack boards, wall bricks, marble -imitated boards, seeded bricks, railway level crossing sleepers, artificial grass, sport court raceways, protection pads, artificial reefs, coast bulwarks, armor blocks, dock bumpers, etc. Obviously, the method in accordance with the present invention can provide a great variety of products and can be applied to a wide range of industries.

As known from the above specific embodiments, the present invention has the following advantages: with the technology of treating powder rubber surface 30, the technology of blending 50 and the technology of extrusion granulation 60, the waste plastic and the waste rubber can be made into raw material master-batch 61 to be made into finished products by hot pressing or injection molding. The raw material master-batch 61 made by the method of the present invention have a quite wide application range and can be applied to various industries and structure product applications. Since the waste plastic and the waste rubber are used as raw material for reproduction, the martial made by the method in accordance with the present invention is environment-friendly and can reduce the waste generation.

While we have shown and described various embodiments in accordance with the present invention, it is clear to those skilled in the art that further embodiments may be made without departing from the scope of the present invention.

What is claimed is:

1. A method for manufacturing an environment-friendly composite material with using polyolefin particles and powder rubber which is made of reclaimed waste rubber and has a average diameter between 10 um-100 um as raw materials, comprising the steps of:
powder rubber surface treatment: using interface treating coupling agent to apply a surface treatment to the powder rubber to improve compatibility between the polyolefin particles and the powder rubber;
additive treatment: according to desired functions, adding different additives to the polyolefin particles and the powder rubber;
blending: using a blender to evenly melt-blend the polyolefin particles and the powder rubber with a melt flow index MI larger than 0.5 g/10 min (10 kg loading, 190° C.); and
extrusion granulating: using a processing machine to granulate the evenly-blended polyolefin particles and powder rubber by means of extrusion, so as to form a granulated raw material.

2. The method for manufacturing an environment-friendly composite material as claimed in claim 1, wherein the polyolefin particles are made by crushing waste rubber that is made from high-intensity polyethylene or lower-intensity polyethylene, polypropylene or ethylene vinyl acetate into particles using a crushing machine.

3. The method for manufacturing an environment-friendly composite material as claimed in claim 1, wherein the polyolefin particles are preferably made from the high-intensity polyethylene.

4. The method for manufacturing an environment-friendly composite material as claimed in claim 1, wherein the powder rubber is made by crushing and grinding waste rubber: using the crushing machine to crush the waste rubber to 40-60 mesh, and then using a grinder to grind the waste rubber into powder rubber with the average particle diameter between 10 um-100 um.

5. The method for manufacturing an environment-friendly composite material as claimed in claim 1, wherein a blending ratio of the polyolefin particles and the powder rubber is between 1 and 1:3.5.

6. The method for manufacturing an environment-friendly composite material as claimed in claim 1, wherein the blending ratio of the polyolefin particles and the powder rubber is preferably 1:2.

7. The method for manufacturing an environment-friendly composite material as claimed in claim 1, wherein the additive is a heat stabilizer.

8. The method for manufacturing an environment-friendly composite material as claimed in claim 1, wherein the additive is a processing aid.

9. The method for manufacturing an environment-friendly composite material as claimed in claim 1, wherein the additive is a flame resisting agent.

10. The method for manufacturing an environment-friendly composite material as claimed in claim 1, wherein the additive is an ultraviolet ray absorption agent.

11. The method for manufacturing an environment-friendly composite material as claimed in claim 1 further comprising a step of injection molding: using an injection molding machine or a hydraulic machine to manufacture the granulated raw material into finished products by means of hot pressing injection or hot pressing molding.

12. The method for manufacturing an environment-friendly composite material as claimed in claim 11 further comprising a step of coating a film: coating a color film during process of injection molding.

13. The method for manufacturing an environment-friendly composite material as claimed in claim 12, wherein the color film is made from ethylene vinyl acetate, thermoplastic rubber, processing aids, pigments and filling agents.
